(19) United States
(12) Patent Application Publication
(10) Pub. No.: US 2024/0385441 A1
(43) Pub. Date: Nov. 21, 2024

(54) IMPROVED COMPACT HEADS UP DISPLAY

(71) Applicant: 3M INNOVATIVE PROPERTIES COMPANY, Saint Paul, MN (US)

(72) Inventors: Jincy Jose, Eagan, MN (US); Byoung Kyu Kim, Hwaseong-si (KR); Craig R. Schardt, Woodbury, MN (US); Stephan J. Pankratz, Eagan, MN (US)

(21) Appl. No.: 18/287,553

(22) PCT Filed: Apr. 20, 2022
(86) PCT No.: PCT/IB2022/053701

§ 371 Date: Oct. 19, 2023

Related U.S. Application Data
(60) Provisional application No. 63/182,212, filed on Apr. 30, 2021.

(51) Int. Cl. G02B 27/01; G02B 27/28

(52) U.S. Cl. CPC G02B 27/0172; G02B 27/0176; G02B 27/283; G02B 2027/015

(57) ABSTRACT

A heads-up display system includes a polarizing beam splitter, a fold mirror, a heads-up display mirror, and a picture generating unit configured to emit a picture light. The polarizing beam splitter, the fold mirror, and the heads-up display mirror define a cavity, and the picture generating unit is disposed outside the cavity. The picture light emitted from the picture-generating unit enters the cavity after being transmitted by the polarizing beam splitter a first time, and the picture light exits the cavity after being transmitted by the polarizing beam splitter a second time.

### SUMMARY

In some aspects of the present description, a heads-up display system is provided, the heads-up display system including a polarizing beam splitter, a fold mirror, a heads-up display mirror, and a picture generating unit configured to emit a picture light. The polarizing beam splitter, the fold mirror, and the heads-up display mirror are configured so as to define a cavity. The picture generating unit is disposed outside of the cavity, such that the picture light emitted from the picture-generating unit enters the cavity after being transmitted by the polarizing beam splitter a first time, and exits the cavity after being transmitted by the polarizing beam splitter a second time.

In some aspects of the present description, a heads-up display for displaying an image to a viewer is provided, the heads-up display including a picture generating unit configured to emit a picture light, at least one mirror, and a polarizing beam splitter. The picture light emitted by the picture generating unit is displayed to the viewer at least after it is reflected at least once by the at least one mirror and transmitted twice by the polarizing beam splitter.

### BRIEF DESCRIPTION OF THE DRAWINGS

FIG. 1 is a schematic view of a compact heads-up display system, in accordance with an embodiment of the present description;

FIG. 2 is a schematic view of a compact heads-up display system, in accordance with an alternate embodiment of the present description;

FIG. 3 is a side view of a cold mirror for use in a compact heads-up display system, in accordance with an embodiment of the present description;

FIGS. 4A and 4B define a light path for a compact heads-up display, in accordance with an embodiment of the present description; and

FIGS. 5A and 5B define a light path for a compact heads-up display, in accordance with an alternate embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

There is an increasing demand for heads up displays (HUD) in automotive markets, but the introduction of additional capabilities (e.g., augmented reality features) has led to a steady increase in the physical volume of a HUD. It is possible to reduce the volume consumed by a HUD by designing a compact HUD where the optical path is folded using polarizing films and mirrors configured to create an optical path that has the proper focal length but which takes up less physical volume. However, such designs can have issues with glare and sunlight reflection, in part due to the orientation and placement of the primary HUD mirror and/or the polarizing beam splitter required in these folded systems, which can cause incident sunlight to be reflected back along the optical path and interfere with the virtual image displayed on the windshield.

According to some aspects of the present description, a heads-up display is provided which reduces or eliminates sunlight reflections in the virtual image. In some embodiments, this may be accomplished by configuring components within the system to provide surface angles that do not contribute to sunlight reflection along the optical path. In some embodiments, the location of the picture generating unit (e.g., a display used to create the virtual image) is shifted in the heads-up display system to allow for a high tilt angle on the polarizing beam splitter while still allowing for minimal use of physical volume in the system. This configuration also helps to eliminate reflections from the primary HUD mirror by rerouting the optical path such that the path of light emitted by the picture generating unit is different than the outgoing path of reflected sunlight.

According to some aspects of the present description, a heads-up display system may include a polarizing beam splitter, a fold mirror, a heads-up display mirror, and a picture generating unit configured to emit a picture light. In some embodiments, the polarizing beam splitter, the fold mirror, and the heads-up display mirror are configured so as to define a cavity (i.e., a space roughly bounded by the planes of the polarizing beam splitter, fold mirror, and heads-up display mirror). In some embodiments, the picture generating unit (e.g., an LCD or OLED display) is disposed outside of the cavity, such that the picture light emitted from the picture-generating unit enters the cavity after being transmitted by the polarizing beam splitter a first time, and exits the cavity after being transmitted by the polarizing beam splitter a second time. Stated another way, in some embodiments, the picture generating unit may be disposed such that the picture light it emits passes through the polarizing beam splitter to enter the cavity, is reflected as required inside the cavity to create the desired optical path (e.g., reflected at least once from the fold mirror, the polarizing beam splitter, and the heads-up display mirror), and passes through the polarizing beam splitter a second time as it exits the cavity to be displayed to a viewer (e.g., the operator of a vehicle).

In some embodiments, the fold mirror may transmit at least 40%, or at least 45%, or at least 50%, or at least 60%, of normally incident light for at least one wavelength in a range from about 700 nm to about 2500 nm (i.e., infrared light). That is, in some embodiments, the fold mirror may be configured as a “cold mirror”, allowing at least a portion of light in the infrared wavelengths to pass through the mirror. These infrared wavelengths are outside the human visible range and can not be used to display information to a viewer but may add unwanted heat to a system. Allowing at least a portion of the infrared light to be transmitted by the fold mirror allows the heat to pass into the exterior of the heads-up display system (e.g., an exterior housing) where it can be more efficiently dissipated.

In some embodiments, the polarizing beam splitter may include a reflective polarizer. In some embodiments, the reflective polarizer may reflect at least 50%, or at least 55%, or at least 60%, or at least 65%, or at least 70% of incident light of a first polarization type (e.g., a linear P-polarization type), and may transmit at least 50%, or at least 55%, or at least 60%, or at least 65%, or at least 70% of incident light of a second polarization type (e.g., a linear S-polarization type). In some embodiments, the polarizing beam splitter may further include a quarter wave plate. In such embodiments, the quarter wave plate may be disposed on or near, and substantially parallel to, the polarizing beam splitter. In some embodiments, instead of the polarizing beam splitter including a quarter wave plate, each of the fold mirror and the heads-up display mirror may include a quarter wave plate.

In some embodiments, at least one of the fold mirror and the heads-up display mirror may be curved. In some embodiments, for example, the heads-up display mirror, or the fold mirror, may have a concave surface, creating a magnifying effect of the picture light. In some embodiments, one of the heads-up display mirror and the fold mirror may be convex, and the other of the heads-up display mirror and the fold mirror may be concave.

In some embodiments, the heads-up display system may further include a glare trap, where the glare trap is disposed such that at least a portion of the picture light is transmitted by the glare trap before forming a virtual image for viewing by a viewer. In some embodiments, the glare trap may include a plurality of spaced-apart, substantially parallel slats extending along a first direction and arranged along a different second direction. In such embodiments, the parallel slats may be oriented in such a manner as to allow the transmission of light at certain angles (e.g., within a 15-degree cone that is substantially parallel to the slats, or substantially parallel to the first direction) and to at least partially block light outside these angles (e.g., outside the 15-degree cone). In some embodiments, the heads-up display system may further include a louver layer which is separate from the glare trap but disposed such that at least a portion of the picture light passes through the louver layer before being transmitted by the glare trap. In some embodiments, the louver layer may include a plurality of spaced apart substantially parallel slats extending along a first direction and arranged along a different second direction.

In some embodiments, the glare trap may be a multi-layer optical film. In some embodiments, at least one of the polarizing beam splitter, the fold mirror, and the heads-up display mirror may be a multilayer optical film.

According to some aspects of the present description, a heads-up display for displaying an image to a viewer includes a picture generating unit configured to emit a picture light, at least one mirror, and a polarizing beam splitter. In some embodiments, the picture light emitted by the picture generating unit may be displayed to the viewer at least after it is reflected at least once by the at least one mirror and transmitted twice by the polarizing beam splitter.

In some embodiments, the at least one mirror may include a fold mirror and a heads-up display mirror. In some embodiments, the at least one mirror may transmit at least 40%, or at least 45%, or at least 50%, or at least 60%, of normally incident light for at least one wavelength in a range from about 700 nm to about 2500 nm (i.e., infrared light). That is, in some embodiments, the at least one mirror may be configured as a “cold mirror”, allowing at least a portion of light in the infrared wavelengths to pass through the mirror.

In some embodiments, the polarizing beam splitter may include a reflective polarizer. In some embodiments, the reflective polarizer may reflect at least 50%, or at least 55%, or at least 60%, or at least 65%, or at least 70% of incident light of a first polarization type (e.g., a linear P-polarization type), and may transmit at least 50%, or at least 55%, or at least 60%, or at least 65%, or at least 70% of incident light of a second polarization type (e.g., a linear S-polarization type). In some embodiments, the polarizing beam splitter may further include a quarter wave plate. In such embodiments, the quarter wave plate may be disposed on or near, and substantially parallel to, the polarizing beam splitter.

In some embodiments, instead of the polarizing beam splitter including a quarter wave plate, the at least one mirror may include a quarter wave plate. In some embodiments, the at least one mirror may be curved. In some embodiments, for example, the at least one mirror may have a concave surface.

In some embodiments, the heads-up display system may further include a glare trap, where the glare trap is disposed such that at least a portion of the picture light is transmitted by the glare trap before forming a virtual image for viewing by a viewer. In some embodiments, the glare trap may include a plurality of spaced-apart, substantially parallel slats extending along a first direction and arranged along a different second direction. In such embodiments, the parallel slats may be oriented in such a manner as to allow the transmission of light at certain angles (e.g., within a 15-degree cone that is substantially parallel to the slats, or substantially parallel to the first direction) and to at least partially block light outside these angles (e.g., outside the 15-degree cone).

In some embodiments, the heads-up display system may further include a louver layer which is separate from the glare trap but disposed such that at least a portion of the picture light passes through the louver layer before being transmitted by the glare trap. In some embodiments, the louver layer may include a plurality of spaced apart substantially parallel slats extending along a first direction and arranged along a different second direction.

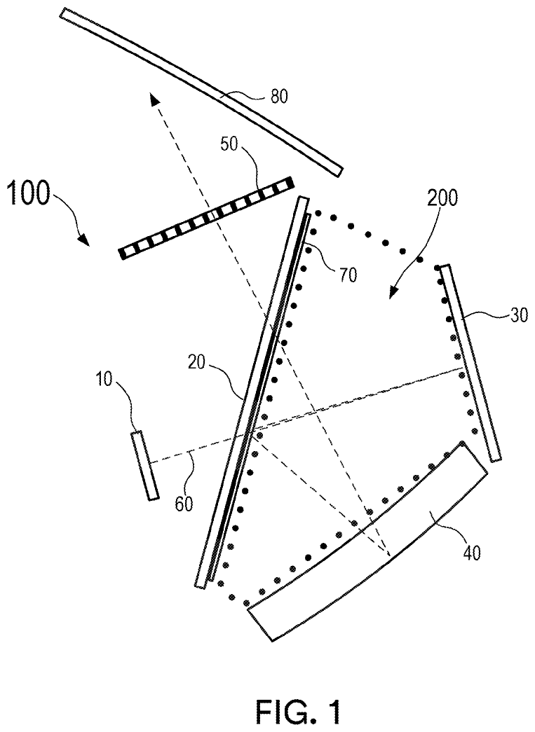

In some embodiments, the glare trap may be a multi-layer optical film. In some embodiments, at least one of the polarizing beam splitter and the at least one mirror may be a multilayer optical film. Turning now to the figures. FIG. 1 is a schematic view of a compact heads-up display system according to the present description. In some embodiments, heads-up display (HUD) system 100 may include a picture generating unit (PGU) 10, a polarizing beam splitter (PBS) 20, a fold mirror 30, and a HUD mirror 40. In some embodiments, the PBS 20, fold mirror 30, and HUD mirror 40 define a cavity 200, such that the PGU 10 is disposed outside of the cavity. In some embodiments, for example, the PGU 10 is disposed on a side of PBS 20 opposite a side of PBS 20 that is facing cavity 200. In such embodiments, an optical path 60 is configured such that a picture light emitted by PGU 10 passes first through PBS 20 to enter cavity 200, is reflected once from fold mirror 30, is reflected by the PBS 20, is reflected off HUD mirror 40, and is finally transmitted out of cavity 200 through PBS 20 to be reflected by windshield 80 for viewing by a viewer.

In some embodiments. PBS 20 is a reflective polarizer configured to substantially transmit (i.e., allow to pass through) light of a first polarization type (e.g., a linear S-polarization) and to substantially reflect light of a second polarization type (e.g., a linear P-polarization). In some embodiments. PBS 20 may further include quarter wave plate (QWP) 70 such that picture light passing through QWP 70 may change from a first polarization type to a different polarization type. For example, light of a linear S-polarization type passing through QWP 70 may be converted to a circular polarization type, and light of a circular polarization type passing through QWP 70 may be converted to either a linear-S or linear-P polarization type, depending on the direction (i.e., the handed-ness) of the circular polarization type. Additional details on the use of QWP 70 in optical path 60 are discussed elsewhere herein.

In some embodiments. HUD display system 100 may further include glare trap 50. In some embodiments, glare trap 50 may include a plurality of spaced apart substantially parallel slats extending along a first direction and arranged along a different second direction. In some embodiments, glare trap 50 may include a separate louver layer, where the spaced-apart, substantially parallel slats are optionally added as a separate layer from glare trap 50. That is, in some embodiments, the parallel slats may be integral to the glare trap, and in other embodiments, the parallel slats may be part of a separate layer disposed on or adjacent to glare trap 50.

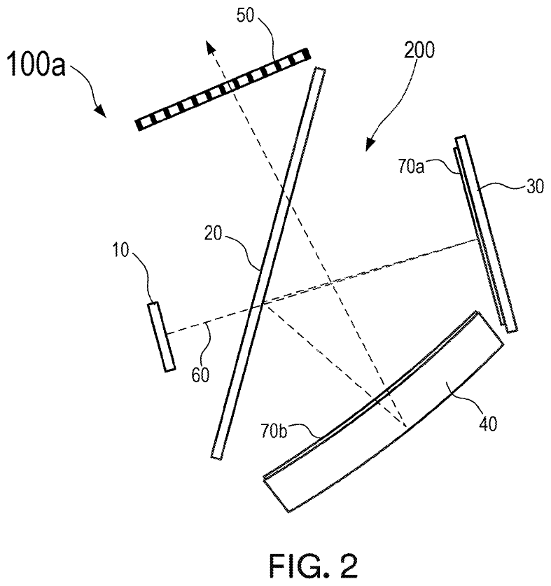

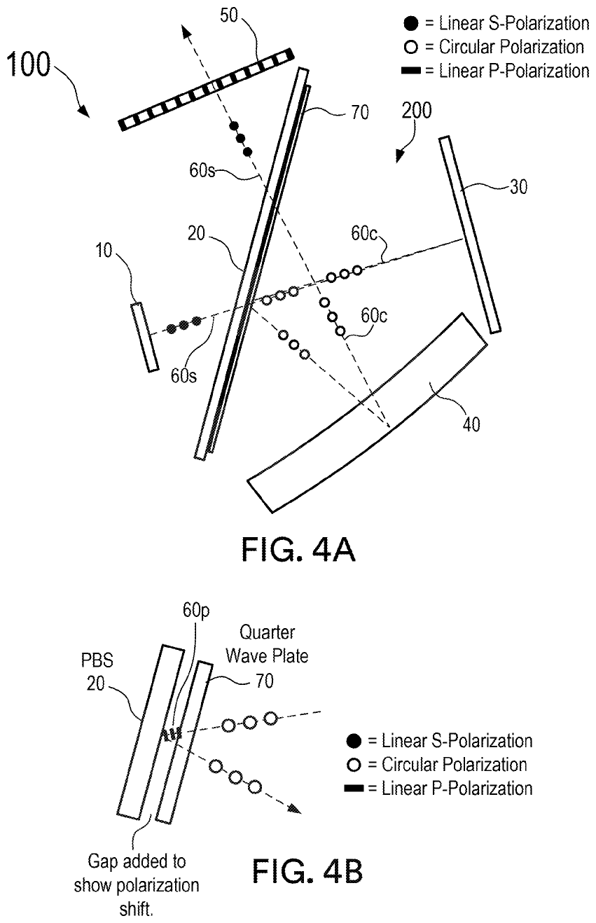

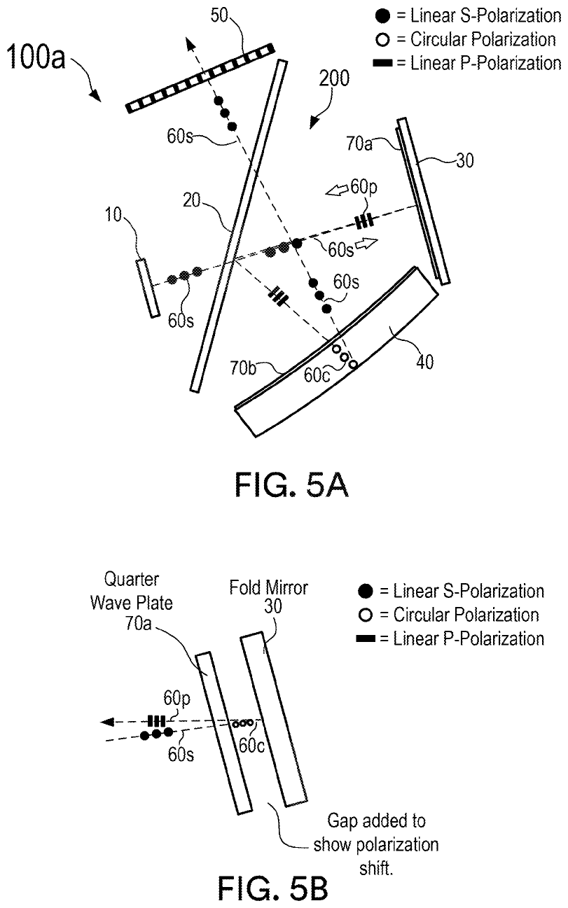

FIG. 2 is a schematic view of an alternate embodiment of a compact heads-up display system according to the present description. Elements in FIG. 2 having the same reference designators as elements of FIG. 1 are assumed to have a similar function as the like-numbered components of FIG. 1 unless specifically described otherwise herein. Compact HUD system 100a of FIG. 2 differs from compact HUD system 100 of FIG. 1 primarily in that quarter wave plate 70 (disposed on PBS 20 in FIG. 1) is replaced by a first QWP 70a disposed on fold mirror 30 and a second QWP 70b on HUD mirror 40. All other elements shown in FIG. 2 are substantially the same as their counterparts in FIG. 1 and need not be explained further. The overall function of HUD system 100a is substantially the same as the overall function of HUD system 100 of FIG. 1; that is, the PGU 10 is disposed outside of cavity 200 formed by PBS 20, fold mirror 30, and HUD mirror 40, and picture light emitted by PGU 10 must enter cavity 200 via the PBS 20 and be transmitted out of cavity 200 also by PBS 20. The differences between HUD system 100 and HUD system 100a are primarily differences in how the picture light changes in polarization type as it follows optical path 60. These differences in the optical path are discussed in FIGS. 4A-4B and FIGS. 5A-5B elsewhere herein. It should be noted that the embodiments of FIG. 1 and FIG. 2 are example embodiments and not intended to be limiting in any way. Other arrangements of components, including positioning of any quarter wave plates, may be within the intent of the present description.

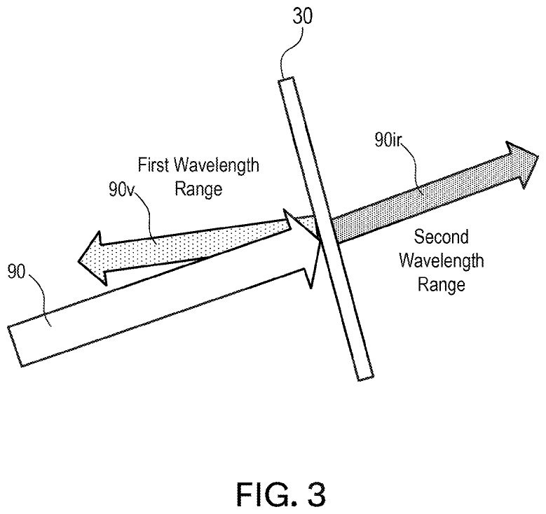

As described elsewhere herein, the compact heads-up display systems of the present description may take advantage of other capabilities built into the system, such as one or more cold mirrors. A cold mirror may substantially reflect at least some wavelengths in a first wavelength range (e.g., a human-visible wavelength range) and substantially transmit at least some wavelengths in a second wavelength range (e.g., an infrared range). This allows the system to transmit at least some portion of infrared wavelengths, which can not make a contribution to the visible image projected for the viewer but which can add heat to the system, to a location where the heat can be more readily dissipated (e.g., the walls of a housing surrounding a HUD, or a heat mitigation system). FIG. 3 provides a side view of a cold mirror for use in a compact heads-up display system, such as HUD system 100 of FIG. 1 or HUD system 100a of FIG. 2. In this case, a mirror (such as fold mirror 30 of FIG. 1) is shown in FIG. 3. Light 90 (which may include light from a picture generating unit or environmental light such as sunlight entering the system by following the optical path back into the HUD) is incident on mirror 30. At least a portion of the light 90v in a first wavelength range (e.g., a visible range containing wavelengths between 400 nm and 650 nm) may be substantially reflected back from mirror 30. Also, at least a portion 90ir of the light in a second wavelength range (e.g., an infrared range containing wavelengths between 700 nm and 2500 nm) may be substantially transmitted by mirror 30. In some embodiments, at least 40%, or at least 50%, or at least 60% or more of infrared light 90ir may be transmitted by mirror 30.

In some embodiments, the picture light emitted by the picture generating unit may be polarized, and the optical path (such as optical path 60. FIG. 1) may be created by manipulating the polarization of the picture light such that it reflects off some surfaces and is transmitted by other surfaces. Also, if the polarization type of the picture light is modified by elements within the HUD system as it follows the optical path, the picture light may be transmitted by a surface from which it was previously reflected, and vice versa. FIGS. 4A and 4B define a light path for a compact heads-up display, describing how the polarization type is modified as it passes through the system. FIGS. 5A and 5B define a similar light path for an alternate embodiment of a compact heads-up display.

Starting with FIGS. 4A and 4B, the optical path 60 is shown for a compact HUD system, such as HUD system 100 of FIG. 1. A picture generating unit 10 emits polarized light 60s. Please note that, for the embodiments described herein, a suffix of “s” (e.g., light 60s) shall be used to indicate light with a linear S polarization type (also known as S-pol light), a suffix of “p” shall be used to indicate light with a linear P polarization type (P-pol light), and a suffix of “c” shall be used to indicate light with a circular polarization type. However, other polarization type schemes than those shown in FIGS. 4A-4B and 5A-5B may be used without deviating from the intent of the present description.

Light 60s impinges on PBS 20 and is substantially transmitted (i.e., the PBS 20 is configured to substantially transmit S-pol light). Light 60s is then passed through QWP 70 which converts the light to circularly polarized light 60c. Light 60c impinges on fold mirror 30, causing the handedness of the circular polarization to reverse. Light 60c then passes back though QWP 70 (refer to FIG. 4B for additional detail), where it is first briefly converted from circularly polarized light 60c to linear polarized P-pol light, before being reflected by PBS 20 and transmitted back through QWP 70, converting it back to circularly polarized light 60c. (Please note that a gap is shown in FIG. 4B between PBS 20 and QWP 70 to more clearly show the shifting of polarization types: however, in reality, there may be no gap.) Finally, circularly polarized light 60c is substantially reflected off of HUD mirror 40 and passes one final time through QWP 70, being converted to S-pol light which is allowed to pass through PBS 20 to be displayed on the windshield (not shown) for viewing. As described elsewhere herein, in some embodiments, optical path 60 (i.e., transmitted light 60s) may also pass through glare trap 50 before being projected onto windshield.

Finally, turning to FIGS. 5A and 5B, which uses QWPs 70a and 70b disposed on mirrors 30 and 40 (rather than a single QWP 70 on the PBS 20) to accomplish a similar result. In FIG. 5A, a picture generating unit 10 emits polarized light 60s. Light 60s impinges on PBS 20 and is substantially transmitted. Light 60s travels across cavity 200 and passes through QWP 70a disposed on fold mirror 30. (See FIG. 5B for additional detail on this part of optical path 60.) Light 60s is converted to circularly polarized light 60c, reflected from fold mirror 30, and passes back through QWP 70a, where it is converted to P-pol light 60p. P-pol light 60p is reflected by PBS 20 and redirected to HUD mirror 40. Before impinging on HUD mirror 40, light 60p passes through the second QWP 70b, is converted to circularly polarized light 60c and reflected from HUD mirror 40. Light 60c passes back through QWP 70b a second time and is converted to S-pol light, which is allowed to be substantially transmitted by PBS 20 to be projected onto a windshield (not shown) for viewing.

As noted elsewhere herein, the polarization schemes shown in the embodiments of FIGS. 4A-4B and 5A-5B are not meant to be limiting, and other polarization schemes may be used to create the folded optical path. For example, the PGU 10 of FIGS. 4A and 5A may emit light with a P-pol linear polarization type instead of the S-pol type, and PBS 20 may instead be configured to transmit P-pol light and reflect S-pol type. In such embodiments, the optical path 60 would still follow the same path as that shown in FIGS. 4A and 5A, with only the polarization types changing at different reflection and transmission points throughout the system. Given the arrangement of the HUD display system shown in FIGS. 4A and 5A, if the PGU 10 emits P-pol light, then the picture light will exit the cavity through the PBS also as P-pol light before passing through the glare trap 50. In such a case, it may be necessary to add a weak P-pol reflective polarizer to the windshield to allow the user to best view the projected image. It should also be noted that the “handedness” of the circular polarization types in the HUD display system (i.e., whether the circular polarization is left-handed or right-handed) is determined by the angle/rotation of the quarter wave plate relative to the optical path as the light passes through, and this also must be considered when configuring the system for a folded optical path.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description. “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A heads-up display system, comprising
a polarizing beam splitter;
a fold mirror;
a heads-up display mirror; and
a picture generating unit configured to emit a picture light;
wherein the polarizing beam splitter, the fold mirror, and the heads-up display mirror define a cavity, the picture generating unit disposed outside the cavity, such that the picture light emitted from the picture generating unit enters the cavity after being transmitted by the polarizing beam splitter a first time and exits the cavity after being transmitted by the polarizing beam splitter a second time.

2. The heads-up display system of claim 1, wherein the fold mirror transmits at least 40% of normally incident light for at least one wavelength in a range from about 700 nm to about 2500 nm.

3. The heads-up display system of claim 1, wherein the polarizing beam splitter comprises a reflective polarizer.

4. The heads-up display system of claim 3, wherein the polarizing beam splitter further comprises a quarter wave plate.

5. The heads-up display system of claim 3, wherein the reflective polarizer transmits at least 60% of an incident light having a first polarization state and reflects at least 60% of the incident light having an orthogonal second polarization state.

6. The heads-up display system of claim 1, wherein at least one of the fold mirror and the heads-up display mirror are curved.

7. The heads-up display system of claim 1, further comprising a glare trap, disposed such that at least a portion of the picture light is transmitted by the glare trap before forming a virtual image for viewing by a viewer.

8. The heads-up display system of claim 7, wherein the glare trap comprises a plurality of spaced apart substantially parallel slats extending along a first direction and arranged along a different second direction.

9. The heads-up display system of claim 7, further comprising a louver layer disposed such that the portion of the picture light passes through the louver layer before being transmitted by the glare trap, the louver layer comprising a plurality of spaced apart substantially parallel slats extending along a first direction and arranged along a different second direction.

10. The heads-up display system of claim 1, wherein each of the fold mirror and the heads-up display mirror further comprises a quarter wave plate.

11. The heads-up display system of claim 1, wherein at least one of the polarizing beam splitter, the fold mirror, and the heads-up display mirror is a multilayer optical film.

12. A heads-up display for displaying an image to a viewer, comprising:
a picture generating unit configured to emit a picture light;
at least one mirror; and
a polarizing beam splitter;
such that the picture light emitted by the picture generating unit is displayed to the viewer at least after it is reflected at least once by the at least one mirror and transmitted twice by the polarizing beam splitter.

13. The heads-up display of claim 12, wherein the at least one mirror transmits at least 40% of normally incident light for at least one wavelength in a second wavelength range from about 700 nm to about 2500.

14. The heads-up display of claim 12, wherein the polarizing beam splitter comprises a reflective polarizer.

15. The heads-up display of claim 14, wherein the polarizing beam splitter further comprises a quarter wave plate.

16. The heads-up display of claim 14, wherein the reflective polarizer transmits at least 60% of an incident light having a first polarization state and reflects at least 60% of the incident light having an orthogonal second polarization state.

17. The heads-up display of claim 12, wherein the at least one mirror is curved.

18. The heads-up display of claim 12, further comprising a glare trap, disposed such that at least a portion of the picture light is transmitted by the glare trap before forming a virtual image for viewing by the viewer.

19. The heads-up display of claim 18, wherein the glare trap comprises a plurality of spaced apart substantially parallel slats extending along a first direction and arranged along a different second direction.

20. The heads-up display of claim 18, further comprising a louver layer disposed such that the portion of the picture light passes through the louver layer before being transmitted by the glare trap, the louver layer comprising a plurality of spaced apart substantially parallel slats extending along a first direction and arranged along a different second direction.

21. The heads-up display of claim 12, wherein the at least one mirror further comprises a quarter wave plate.

22. The heads-up display of claim 12, wherein at least one of the polarizing beam splitter and the at least one mirror is a multilayer optical film.
